(19) United States
(12) Patent Application Publication
(10) Pub. No.: US 2006/0066585 A1
(43) Pub. Date: Mar. 30, 2006

(54) Apparatus for induced capacitor

(75) Inventor: Yi-Chan Lin, Taipei City (TW)

Correspondence Address: BRUCE H. TROXELL, SUITE 1404, 5205 LEESBURG PIKE, FALLS CHURCH, VA, 22041, US

(73) Assignee: Holtek Semiconductor Inc.

(21) Appl. No.: 11/068,981

(22) Filed: Mar. 2, 2005

(30) Foreign Application Priority Data
Sep. 24, 2004 (TW) 93128953

(51) Int. Cl. G09G 5/00

(52) U.S. Cl. 345/173

(57) ABSTRACT

Disclosed is an apparatus for induced capacitor, an insulating substrate; and a plurality of capacitive sensing devices, being arranged on the insulating substrate in a matrix form, each of the plurality of capacitive sensing devices further comprising: a first electrode; and a second electrode, having an inner rim and an outer rim, being disposed circumferentially surrounding the first electrode while separating the second electrode from first electrode by a distance so as to form an equivalent capacitance therebetween, wherein a potential of each capacitive sensing device formed between the two electrodes is adjusted to be a predetermined value by adjusting the distance between the inner rim of the second electrode and the circumference of the first electrode while keeping the outer rim of the second electrode fixed.

### FIELD OF THE INVENTION

The present invention relates to an apparatus for induced capacitor, and more particularly, to an apparatus for induced capacitor capable of conveniently adjusting the equivalent capacitance of capacitance sensing devices arranged therein.

### BACKGROUND OF THE INVENTION

Generally, there are two types of sensing interfaces used by touch panels, which are capacitive type and resistive type. In the case of the capacitive type, a plurality of capacitive touch keys, serving as a sensing medium, have to be formed uniformly on an insulating substrate, such as FR4 substrate and membrane, etc.

The patterning designs of capacitive touch key commonly available are spiral pattern as shown in FIG. 1, comb-like pattern as shown in FIG. 2, and snail-like pattern as shown in FIG. 3, thereby forming an equivalent capacitance. With this configuration, a pulse may be sent by a control circuit to charge the touch keys of a touch panel so as to produce a potential on each of the touch keys instantaneously, and thereafter when a finger of a user touches/presses one of the touch keys, charges in the referring touch key is absorbed by the finger and the potential as mentioned decreases, moreover, as the control circuit detects the decreasing potential to be smaller than a threshold, an associated function corresponding to the referring touch key is being activated. The operation of the capacitive touch panel is undertaken as the context described above.

However, the touch keys are possibly not being charged uniformly due to several factors associated therewith, for example, amount of the touch keys arranged in a touch panel, deficient design of the touch keys and an unevenly formed insulating substrate. In these cases, the potentials generated on the touch keys are not identical (not uniform). Even, a number of potentials may be lower than the threshold and thus the corresponding touch keys are erroneously activated with the associated function by the control circuit at a time before the corresponding touch keys are touched/pressed by the user. Therefore, a touch panel has to be designed with capability of adjusting the equivalent capacitance of each touch key as desired so that uniform potentials may be obtained as a pulse charging the touch keys is applied.

However, to adjust the equivalent capacitances in the spiral, comb-like or snail-like touch keys, the thickness of wires provided within the patterns is to be adjusted on the basis following the function of C=(ε×A)/D, wherein C is equivalent capacitance, ε is dielectric coefficient, A is area and D is distance between wires. For example, while it is intended to increase the equivalent capacitance, either the overall pattern is to be enlarged so that the wires in the pattern are widened (i.e. areas of the wires increased) or the overall pattern is to be shrunk for reducing the separations between wires. However, if the equivalent capacitance is increased by enlarging the area, the complexity of designing the touch keys as well as the cost of producing the same may increase since the touch keys may have different shapes and dimensions, and if the equivalent capacitance is increased by reducing the separation between wires, the electric fields induced by the equivalent capacitances in the touch keys reduces correspondingly, which causes the touch keys to have poor sensitivity and functionality.

### SUMMARY OF THE INVENTION

It is, therefore, an object of the present invention is to provide a capacitive sensing device capable of conveniently adjusting the equivalent capacitance of the same while the area of the device is maintained unchanged.

It is another object to provide an apparatus for induced capacitor capable of conveniently adjusting the equivalent capacitance of each capacitance sensing devices arranged therein while the overall area of the plural capacitance sensing devices arranged therein is being maintained unchanged.

The capacitance sensing device of the present invention comprises: a first electrode; and a second electrode, being disposed circumferentially surrounding the first electrode while separating the second electrode from first electrode by a distance so as to form an equivalent capacitance therebetween.

The apparatus for induced capacitor of the present invention comprises: an insulating substrate; and a plurality of capacitive sensing devices, arranged on the insulating substrate in a matrix form; wherein each capacitive sensing device further comprises: a first electrode; and a second electrode, being disposed circumferentially surrounding the first electrode while separating the second electrode from first electrode by a distance so as to form an equivalent capacitance therebetween.

### BRIEF DESCRIPTION OF THE DRAWINGS

FIG. 1 is a schematic illustration of a prior spiral touch key.

FIG. 2 is a schematic illustration of a prior comb-like touch key.

FIG. 3 is a schematic illustration of a prior snail-like touch key.

FIG. 4 is a schematic circuit block diagram showing an apparatus for induced capacitor according to an embodiment of the present invention.

FIG. 5 is an enlarge view of a capacitive sensing device according to the embodiment of the present invention seen in FIG. 4.

FIG. 6 is a schematic diagram showing a capacitive sensing device with widened second electrode according to the embodiment of the present invention seen in FIG. 4.

FIG. 7 is a schematic diagram showing a capacitive sensing device with enlarged first electrode according to the embodiment of the present invention seen in FIG. 4.

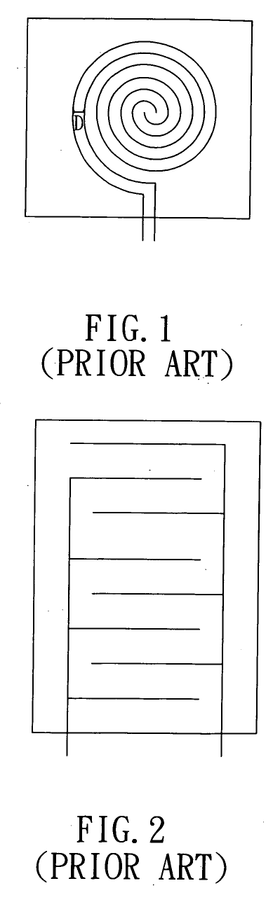

### DESCRIPTION OF THE PREFERRED EMBODIMENT

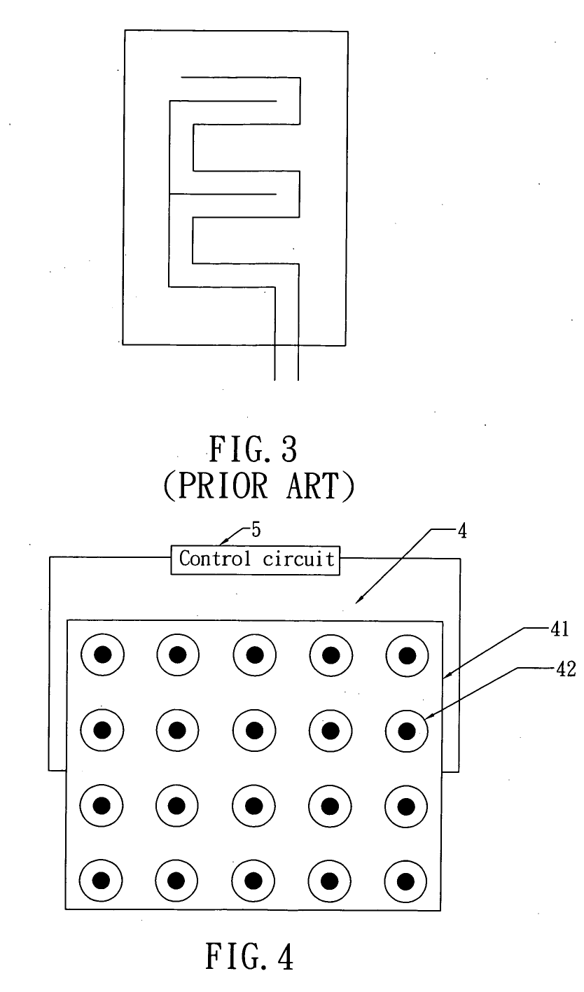

Pleas refer to FIG. 4, which is is a schematic circuit block diagram showing an apparatus for induced capacitor according to an embodiment of the present invention. The apparatus for induced capacitor 4 is a capacitive touch panel, comprising an insulating substrate 41 and a plurality of capacitive sensing devices 42.

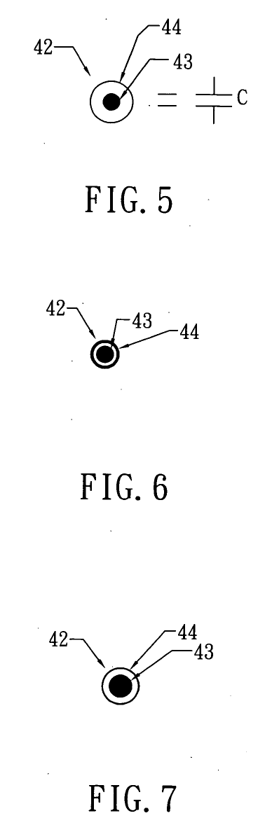

The insulating substrate 41 is a circuit board selected from the group consisting of a FR4 circuit board, a circuit membrane and the likes. Each of the capacitive sensing devices 42 is used as a touch key, being independently arranged on the insulating substrate 41 and together forming a matrix form. Referring to FIG. 5, an enlarge view of a capacitive sensing device according to the embodiment of the present invention seen in FIG. 4 is illustrated therein. As shown, each of the capacitive sensing devices 42 further comprises a first electrode 43 and a second electrodes 44.

In this embodiment, the first electrode 43 is a structure of circular profile having an area (A). The second electrode 44 is a ring, being disposed circumferentially surrounding the first electrode while separating the second electrode from first electrode by a distance (D) so as to form an equivalent capacitance therebetween. As such, an equivalent capacitance is formed between the first electrode 43 and second electrodes 44 and the equivalent capacitance may be obtained based on the function of C=(ε×A)/D, wherein ε is dielectric coefficient of the insulating substrate.

As seen in FIG. 4, the apparatus for induced capacitor 4 is controlled by a control circuit 5 in a way that a pulse may be sent by a control circuit to charge either the first electrode 43 or the second electrode 44 of the capacitive sensing devices 42 of the apparatus for induced capacitor 4 so as to produce a potential on each capacitive sensing device 42 instantaneously, and thereafter when a finger of a user touches/presses the referring capacitive sensing device 42, charges in the referring capacitive sensing device 42 is absorbed by the finger and the potential as mentioned decreases, moreover, as the control circuit 5 detects the decreasing potential to be smaller than a threshold, an associated function corresponding to the referring capacitive sensing device 42 is being activated.

However, the pulse may attenuate as the transmit distance increases and the capacitive sensing devices may have deficient designs or the material of the insulating substrate may non-uniformly distributed, such that the potentials of the capacitive sensing devices 42 may not be uniform, i.e. not identical as compared to one another. In this case, the equivalent capacitances of the capacitive sensing devices 42 should be adequately adjusted with the consideration of the factors mentioned taken. As said in the foregoing context in the prior art section, the areas of the capacitive sensing devices 42 are preferably kept constant so as not to increase cost and complexity of the device. In this regard, an outer rim of the second electrode 44 is kept fixed and only the distance D between an inner rim of the second electrode 44 and the first electrode 43 is varied for each capacitive sensing device 42 to adjust the equivalent capacitance of the capacitive sensing device 42. As such, the equivalent capacitance may be adjusted to a desired value without compromising a need of the area of the corresponding capacitive sensing device.

One of the adjustment methods with respect to the distance between the first electrode 43 and the inner rim of the second electrode 44 may be performed with reference to FIG. 6. In this embodiment, the first electrode 43 is kept fixed and the second electrode 44 is adjusted in its width in a radial direction. For example, the radial width of the second electrode 44 is widened and thus the distance D between the first and second electrodes 43,44 is shortened, enabling the equivalent capacitance of the capacitive sensing device 42 to be increased. Alternatively, that the second electrode 44 is maintained fixed while the first electrode 43 is varied in area as shown in FIG. 7 may also achieve the same effect of the equivalent capacitance adjustment. For example, the second electrode 44 is maintained fixed and the first electrode 43 is increased in area may shorten the distance between the first and second electrodes 43,44, and thus the equivalent capacitance therebetween is adjusted.

Therefore, the equivalent capacitance of each of the capacitive sensing devices in the apparatus for induced capacitor may be adjusted freely by varying the structures of the pairs of the first and second electrodes 43,44 without changing the overall area of each of the capacitive sensing devices 42 and thus the whole capacitive sensing devices 42. After the adjustment, the capacitive sensing devices 42 may have uniform/identical potentials as compared to one another when charged so as to avoid erroneous actions occurred and improve the sensitivity of the touch panel.

Although a pattern of the first electrode 43 in the capacitive sensing device 42 has been described with the specific pattern as above used, the pattern of the first electrode 43 may also be a structure of rectangle or other polygons or equilateral polygons profile. The inventive capacitive sensing devices may also be utilized in capacitive sensing associated electronic switches in addition to general capacitive touch panels, such as the one as used for the above description, so as to solve a problem of uniform equivalent capacitances taken place in the electronic switches.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A capacitive sensing device, comprising:
a first electrode; and
a second electrode, having an inner rim and an outer rim, being disposed circumferentially surrounding the first electrode while separating the second electrode from first electrode by a distance so as to form an equivalent capacitance therebetween.

2. The capacitive sensing device as recited in claim 1, wherein a potential is induced between the first and second electrodes while charging any one of the two electrodes.

3. The capacitive sensing device as recited in claim 2, wherein the potential of the capacitive sensing device is adjusted to be a predetermined value by adjusting the distance between the inner rim of the second electrode and the circumference of the first electrode while keeping the outer rim of the second electrode fixed.

4. The capacitive sensing device as recited in claim 3, wherein the distance between the inner rim of the second electrode and the first electrode is adjusted by varying the area of the first electrode.

5. The capacitive sensing device as recited in claim 3, wherein the distance between the inner rim of the second electrode and the first electrode is adjusted by varying the width of the second electrode.

6. The capacitive sensing device as recited in claim 1, wherein the first electrode has a structure of circular profile.

7. The capacitive sensing device as recited in claim 1, wherein the first electrode has a structure of polygonal profile.

8. An apparatus for induced capacitor, comprising:
an insulating substrate; and
a plurality of capacitive sensing devices, disposed on the insulating substrate in a matrix form, each capacitive sensing device further comprising:
a first electrode; and
a second electrode, having an inner rim and an outer rim, being disposed circumferentially surrounding the first electrode while separating the second electrode, from first electrode by a distance so as to form an equivalent capacitance therebetween.

9. The apparatus for induced capacitor as recited in claim 8, wherein a potential is induced between the first and second electrodes while charging any one of the two electrodes.

10. The apparatus for induced capacitor as recited in claim 9, wherein the potential of the capacitive sensing device is adjusted to be a predetermined value by adjusting the distance between the inner rim of the second electrode and the circumference of the first electrode while keeping the outer rim of the second electrode fixed.

11. The apparatus for induced capacitor as recited in claim 10, wherein the distance between the inner rim of the second electrode and the first electrode is adjusted by varying the area of the first electrode.

12. The apparatus for induced capacitor as recited in claim 10, wherein the distance between the inner rim of the second electrode and the first electrode is adjusted by varying the width of the second electrode.

13. The apparatus for induced capacitor as recited in claim 8, wherein the first electrode has a structure of circular profile.

14. The apparatus for induced capacitor as recited in claim 8, wherein the first electrode has structure of polygonal profile.

15. The apparatus for induced capacitor as recited in claim 9, wherein the apparatus for induced capacitor is a touch panel and the plural capacitive sensing devices are a plurality of touch keys of the touch panel, and the potential of one the plural capacitive sensing device is caused to decrease while the touch key corresponding to the capacitive sensing device is touched.

16. The apparatus for induced capacitor as recited in claim 8, wherein the insulating substrate is a FR4 board.

17. The apparatus for induced capacitor as recited in claim 8, wherein the insulating substrate is a membrane.
